(19) United States
(12) Patent Application Publication
(10) Pub. No.: US 2005/0255425 A1
(43) Pub. Date: Nov. 17, 2005

(54) Mixing tip for dental materials

(76) Inventor: Paul Richard Pierson, Camden, DE (US)

Correspondence Address: Douglas J. Hura, Esquire;DENTSPLY International Inc., 570 West College Avenue, P.O. Box 872, York, PA, 17405-0872, US

(21) Appl. No.: 11/184,422

(22) Filed: Jul. 19, 2005

Related U.S. Application Data
(63) Continuation-in-part of application No. 10/760,036, filed on Jan. 16, 2004, now abandoned.
Application No. 10/760,036 is a continuation-in-part of application No. 09/960,151, filed on Sep. 21, 2001, now abandoned.
(60) Provisional application No. 60/215,160, filed on Sep. 21, 2000.

(51) Int. Cl. A61C 5/04

(52) U.S. Cl. 433/89

(57) ABSTRACT

A tip (10) for the dispensing of materials includes a housing (11) having first and second chambers (12, 13) contained therein. The chambers (12, 13) communicate with a mixing reservoir (19) and a hollow barrel (21). The hollow barrel (21) has an output orifice (51) and is in fluid communication with the mixing reservoir (19). Disposed within hollow barrel (21) is a static mixing device (30).

### RELATED APPLICATIONS

This application is a Continuation-In-Part application of U.S. patent application Ser. No. 10/760,036 (Case LDC-922-1B CIP) filed Jan. 16, 2004, which is a Continuation-In-Part application of U.S. patent application Ser. No. 09/960,151 (Case LDC-922-1B) filed Sep. 21, 2001, which claims the benefit from Provisional Application No. 60/215,160 filed Sep. 21, 2000.

### TECHNICAL FIELD

The present invention is directed toward a mixing tip for dispensing materials. More particularly, the invention is a tip for mixing and dispensing materials.

### BACKGROUND OF THE INVENTION

Various types of material, such as medical or dental materials are often packaged in preloaded sealed cartridges or in preloaded syringes. For example, U.S. Pat. No. 5,707,234 discloses a cartridge for dispensing dental materials. The cartridge is preloaded and is inserted into an ejector device at the time of use. The ejector device is manipulated such that a piston is caused to enter the cartridge and the material in the cartridge is expelled through a nozzle. It also often the case that a non-mixing tip is placed onto a syringe containing a material to be dispensed.

Especially in the case of preloaded cartridges, it is often the case that a material must first be mixed with another material in order to form the final product. These materials are often preloaded into cartridges used for a single application of the material. These types of cartridges are sometimes referred to as being a “unit dose.”

When a material is mixed at the time of use, especially in the case of a unit dose of dental material, it is often important to not only precisely mix the two components but to also place the components in the proper location in the oral cavity.

A need exists therefore for a mixing tip which will not only mix materials but will facilitate their exact application in for example, the oral cavity.

### BRIEF DESCRIPTION OF THE DRAWINGS

FIG. 1 is a front elevational, partially sectional view of a mixing tip according to the present invention.

FIG. 2 is a top plan view of one embodiment of a mixing tip according to the present invention.

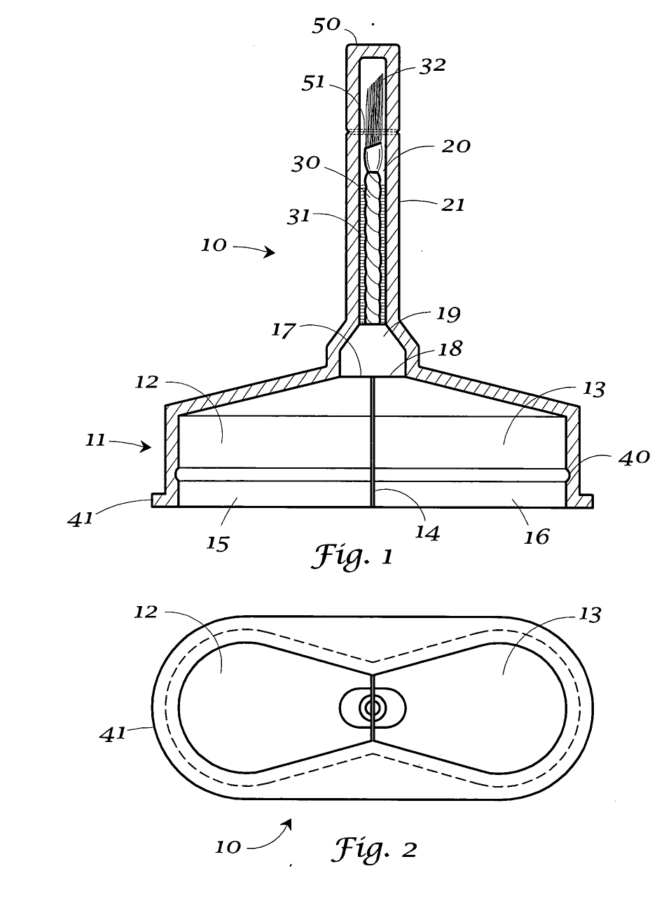

### PREFERRED EMBODIMENTS FOR CARRYING OUT THE INVENTION

As shown in the drawings, the present invention is directed to a mixing tip 10 which can be alternatively preloaded or used with a loaded ejection device or syringe (not shown). More particularly, the mixing tip 10 is used with a dual-component material (not shown) which may be required to be mixed substantially immediately before application. While useful with any number of such materials, the present invention has particular application to dual-component dental materials.

Mixing device 10 has a housing generally designated by the number 11 on the drawings. Housing 11 is preferably provided with first and second chambers 12 and 13 which are in communication with each other. Chambers 12 and 13 combine to form a sleeve which is a means to connect mixing device 10 to a preloaded cartridge (not shown).

According to one embodiment of the invention, chambers 12 and 13 are separated by a plenum 14 and each has an input orifice 15 and 16 respectively, and an output orifice 17 and 18 respectively. The output orifices 17, 18 communicate with a mixing reservoir 19 and a hollow dispensing barrel 21.

Chamber 19 is in communication with the interior passage 20 of a dispensing barrel 21. It will be appreciated therefore, that material dispensed into chamber 19 will be expressed through interior passage 20. Dispensing barrel 21 is provided with an output orifice 51 which may be closed with a suitable cap 50 until removed.

Disposed within interior passage 20 is a static mixing device 30. Static mixing device 30 is preferably a length of twisted wire which is generally designated by the number 31 on the attached drawings. While the length of twisted wire 31 is not necessarily critical to the practice of the present invention, it is preferred that the wire be approximately the same length as barrel 21.

In another preferred embodiment of the invention, static mixing element 30 is provided at one end with a brush 32. It is to be appreciated that material flowing through barrel 21 will be caused to physically contact brush 32. By manipulating mixing tip 10, brush 32 can be used to facilitate precise application of the expressed material. The material from which brush 32 is fabricated is not critical to the practice of the present invention. The material should be substantially impervious to degradation caused by the material expressed through the mixing tip 10, and should not cause substantial discomfort or would be otherwise detrimental for the intended purpose. One preferred type of brush would be nylon bristles that are attached to static mixing device 30 in any conventional manner.

According to another embodiment of the invention, barrel 21 is made of a flexible, preferably plastic material that can be bent at any of a variety of angles in order to facilitate application of the expressed material

First and second chambers 12 and 13 are preferably provided at an end distal to static mixing device 30 or at some other location therein, with a detent or snap bead 40 and a flange 41 which will mate to the device which is used to express material through mixing tip 10. While this is one preferred method of mating and affixing to the expressing device, any other conventional such method is also within the scope of the present invention.

A mixing and dispensing syringe is shown by way of example in U.S. Pat. No. 4,776,704 which is hereby incorporated by reference or its disclosure.

It is apparent therefore, that a mixing tip according to the present invention is an advantageous improvement over dispensing tips previously known, and otherwise provides an improvement in the art.

1. A tip for the dispensing, mixing and application of a material having first and second components to be mixed prior to application comprising a housing, first and second chambers disposed within said housing and in communication, said chambers providing a means to attach said mixing tip to a preloaded cartridge fluidly communicating with a mixing reservoir, a dispensing barrel having a hollow interior also in fluid communication with said mixing reservoir and having an output orifice, a static mixing device disposed within said barrel, said static mixing device comprising a twisted wire component.

2. A tip as in claim 1 wherein static mixing device is also provided with a brush at least partially protruding from said barrel.

3. A tip as in claim 1 wherein said barrel and said enclosed static mixing device can be bent at an angle.
